(19) United States
(12) Patent Application Publication
(10) Pub. No.: US 2020/0372427 A1
(43) Pub. Date: Nov. 26, 2020

(54) TRAVEL ORDER ALLOCATION METHOD, CONTROLLER, AND TRANSPORT SYSTEM COMPRISING CONTROLLER

(71) Applicants: MURATA MACHINERY, LTD., Kyoto-shi (JP); OSAKA UNIVERSITY, Osaka (JP)

(72) Inventors: Tatsushi Nishi, Suita-shi (JP); Kosei Nishida, Suita-shi (JP); Hideki Kaname, Kyoto (JP); Kenji Kumagai, Inuyama-shi (JP); Toshimitsu Higashi, Inuyama-shi (JP)

(21) Appl. No.: 16/881,229

(22) Filed: May 22, 2020

(30) Foreign Application Priority Data
May 22, 2019 (JP) 2019-095740

(51) Int. Cl. G06Q 10/06; G05D 1/02

(52) U.S. Cl. CPC G06Q 10/06314; G05D 1/0289

(57) ABSTRACT

A transport task allocation method includes provisionally allocating a transport task to a set of traveling carriages, determining travel schedules of the traveling carriages, computing a task evaluation value with respect to the transport task allocated to the traveling carriage that travels according to the travel schedule and an overall allocations evaluation value with respect to overall allocations, changing the currently allocated traveling carriage for at least one transport task based on the task evaluation value, and determining overall allocations corresponding to a best overall allocations evaluation value that satisfies a predetermined condition.

### CROSS-REFERENCE TO RELATED APPLICATIONS

This application claims the benefit of priority to Japanese Patent Application No. 2019-095740 filed on May 22, 2019. The entire contents of this application are hereby incorporated herein by reference.

### BACKGROUND OF THE INVENTION

### 1. Field of the Invention

At least one preferred embodiment of the present invention relates to an allocation of transfer requests for an automatic travel of automated guided vehicles.

### 2. Description of the Related Art

For example, a transport system for a semiconductor manufacturing plant and the like requires that transport time up to a transport destination be minimized, or that material arrives at a transport destination just-in-time for a designated time. Japanese Patent No. 4,782,194 discloses a transport system that takes such a request into account.

In a transport method used for the transport system of the Japanese Patent No. 4,782,194, with respect to a transfer request, based on a distribution of the transfer times and a premise that a penalty is minimized, a schedule of a transfer scenario is generated. The penalty is evaluated based on a convolution and the like of distribution of arrival times and an evaluation function. The distribution of the transfer times is estimated from a mean value and a variance of transfer time obtained from historical actual values and the like.

In the configuration of Japanese Patent No. 4,782,194, computer processing using mathematical programming or the like is required in order to generate a schedule of a transfer scenario. However, for example, in a transport system for a semiconductor plant where the number of traveling carriages is in the thousands, it is difficult to create a schedule to shorten the total transfer time and/or to realize just-in-time (JIT) transfer by computer processing using mathematical programming in a practical time. Thus, room for improvement remains.

### SUMMARY OF THE INVENTION

Preferred embodiments of the present invention provide travel order allocation methods that each can obtain allocations of travel order appropriate for at least one of total completion time and JIT performance achieved with shortened processing time.

A preferred embodiment of the present invention provides a travel order allocation method in which a travel order including positional information of a first designated position and a second designated position is allocated to an automated guided vehicle in a routing system including a set of vehicles that perform an automatic travel. The travel order allocation method includes a first step, a second step, a third step, a fourth step, and a fifth step. In the first step, each of a set of travel orders is provisionally allocated to any one of vehicles. In the second step, for each of a set of vehicles, a travel schedule in which the vehicle travels from a departure position in order of the first designated position and the second designated position included in the travel order provisionally allocated in the first step is determined. The travel schedule is determined such that vehicles performing an automatic travel do not interfere with each other. In the third step, an order evaluation value for each of the travel orders and an overall allocations evaluation value for overall allocations, in the case where each of the vehicles performs an automatic travel in accordance with each of the travel schedules determined in the second step, are computed. The overall allocations include all combinations in which all travel orders are allocated to a set of vehicles, respectively. In the fourth step, based on the order evaluation value computed in the third step, the vehicle currently allocated for at least one of the travel orders is changed. In the fifth step, the overall allocations corresponding to the best most recent overall allocations evaluation value are determined, when it is determined that trends of the best overall allocations evaluation value among a plurality of the overall allocations evaluation values obtained by repeatedly executing the second step, the third step, and the fourth step has converged.

As a result, it is possible to obtain allocations having a good overall allocations evaluation value in the reduced processing time. This effect is particularly suitable in a transport system of a large-scale plant, a large automatic stocker, and the like, having a large number of vehicles.

In the travel order allocation method, it is preferable to perform the following. In the fourth step included in the method, the travel order, corresponding to the order evaluation value having the worst value among all the order evaluation values computed by the third step, is provisionally allocated to each of a set of vehicles as a priority travel order. In the fourth step, the travel schedule of each vehicle is determined for the priority travel order. In the fourth step, each of the order evaluation values, in the case where each vehicle travels in accordance with the travel schedule for the determined priority travel order, is computed in association with each of the vehicles. In the fourth step, the priority travel order is allocated to the vehicle corresponding to the best order evaluation value among all the order evaluation values which are computed.

As a result, with respect to the travel order provisionally allocated, the travel order corresponding to the allocation with the worst evaluation is reallocated preferentially. This enables reducing processing time to find the overall allocations close to the ideal.

The travel order allocation method is preferably performed as follows. The overall allocations evaluation value used in the travel order allocation method is computed based on an error time and a total completion time. The error time is a difference between an estimated arrival time at the second designated position and a pre-specified designated arrival time of the vehicle traveling in accordance with the travel schedule. The total completion time is a time from a pre-specified start time until the vehicle arrives at the second designated position. The best overall allocations evaluation value is the overall allocations evaluation value having a minimum value among a plurality of the overall allocations evaluation values.

As a result, it is possible to obtain allocations close to the ideal by considering both a JIT performance and a total completion time. The JIT performance is represented by an error between the estimated arrival time and the designated arrival time, by square values of the error, or the like.

The travel order allocation method is preferably performed as follows. The overall allocations evaluation value used in the method is computed based on the error time weighted by a first parameter and the total completion time weighted by a second parameter. Each of the first parameter and the second parameter is adjustable.

As a result, by adjusting each parameter, it is possible to obtain allocations corresponding to the degree of importance with respect to the JIT performance and the total completion time, respectively. It is also possible to obtain allocations considering only one of the JIT performance and the total completion time, by setting one of the weights to zero.

The travel order allocation method is preferably performed as follows. The overall allocations evaluation value used in the method is computed based on an error time and a total completion time. The error time is a difference between an estimated arrival time at the second designated position and a pre-specified designated arrival time of the vehicle traveling in accordance with the travel schedule. The total completion time is a time from the pre-specified start time until the vehicle arrives at the second designated position. The overall allocations evaluation value is a sum of each the order evaluation value in the overall allocations corresponding to the overall allocations evaluation value.

As a result, it is possible to obtain allocations close to the ideal by considering both the JIT performance and the total completion time, with respect to travel of a single vehicle.

The travel order allocation method is preferably performed as follows. The travel order includes a designated arrival time which is a time to arrival to the second designated position. In the first step, for each of the travel orders, the vehicle which is a subject to which the travel order is provisionally allocated, is determined based on each of the initial evaluation values in the case where the travel order is allocated to each of the vehicles. The initial evaluation value is a value based on a margin time obtained by subtracting the shortest necessary time from a scheduled handling time. The shortest necessary time is the shortest time required for the vehicle to which the travel order is allocated to travel from a current position to the second designated position. The scheduled handling time is the time from a pre-specified start time to the designated arrival time. The initial evaluation values are computed for all combinations when each of all the travel orders is provisionally allocated to each of all the vehicles so that one of all the travel orders is provisionally allocated to each of all the vehicles. In the first step, based on all the computed initial evaluation values, in order of the larger initial evaluation values, the travel order corresponding to the initial evaluation value is provisionally allocated to the vehicle corresponding to the initial evaluation value.

As a result, in the initial allocation, a plurality of travel orders can be reasonably provisionally allocated to a set of vehicles. This enables reduction of time to obtain the overall allocations close to the ideal.

The travel order allocation method is preferably performed as follows. The vehicle is a traveling carriage that loads a designated load at the first designated position, which is a designated loading position, and unloads the load at the second designated position, which is a designated unloading position. The travel order is a transport order to cause the traveling carriage to travel to the first designated position and then to travel to the second designated position.

As a result, it is possible to obtain in a short time the overall allocations in which the transport order is properly allocated to each of a set of traveling carriages.

Another preferred embodiment of the present invention provides a controller to determine the vehicle to be allocated to the travel order by using the travel order allocation method.

As a result, it is possible to obtain overall allocations having a good overall allocations evaluation value in the reduced processing time. This effect is particularly suitable in a transport system of a large-scale plant, a large automatic stocker, and the like, having a large number of vehicles.

An additional preferred embodiment of the present invention provides a transport system including the controller and a set of transport devices that perform an automatic travel based on a travel order allocated by the controller.

As a result, it is possible to allocate a plurality of transport orders to the transport devices efficiently and reasonably to improve the work efficiency of transport system.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a schematic view showing a configuration of a plant using a transport system according to a preferred embodiment of the present invention.

FIG. 2 is a block diagram showing a configuration of the transport system.

FIG. 3 is a flowchart showing a transport task allocation method.

FIG. 4A is a schematic view showing a set of traveling carriages and their routes. FIG. 4B is an image view showing an error time and a total completion time.

FIGS. 5A and 5B are diagrams showing a comparison result between a preferred embodiment of the present invention and a conventional solution method.

### DETAILED DESCRIPTION OF THE PREFERRED EMBODIMENTS

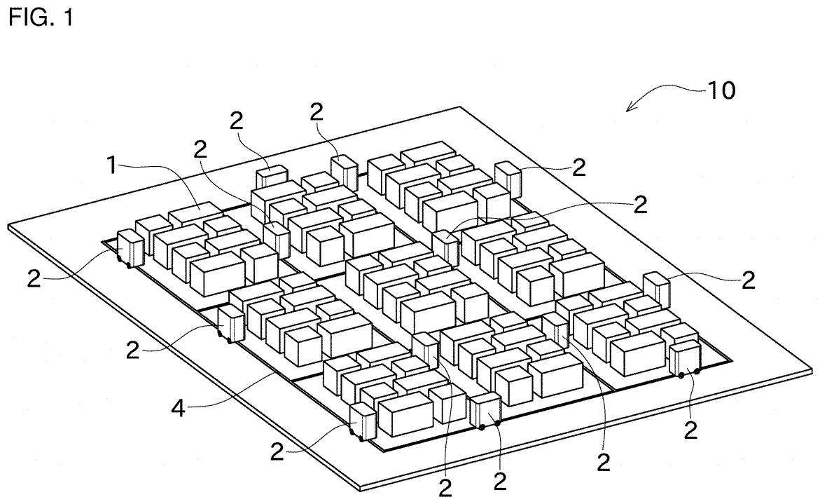

Next, preferred embodiments of the present invention will be described with reference to the drawings. FIG. 1 is a schematic view showing a plant 10 using a transport system 100 according to a preferred embodiment of the present invention.

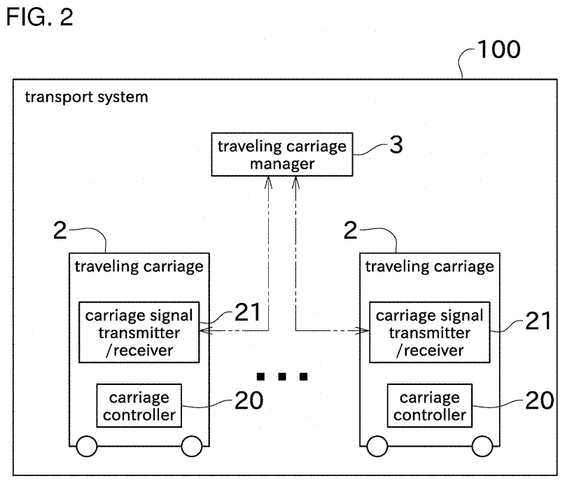

The transport system 100 according to a preferred embodiment of the present invention, for example, as shown in FIG. 1, is provided in a semiconductor manufacturing plant 10 or the like, which includes a plurality of processors 1. The transport system 100 is, for example, an automatic transport system to transport the material such as FOUP (Front Opening Unify Pod) or the like. The transport system 100 includes a set of traveling carriages (vehicles) 2 and traveling carriage manager (controller) 3, as shown in FIG. 2.

The processor 1 is a device that performs a variety of processes to fabricate semiconductors. The plant 10 having the transport system 100 is provided with facilities of variety in place of the processor 1 or in addition to the processor 1. For example, a storage, such as an automatic stocker, a stacker rack, or the like, can be provided. The automatic stocker can store a plurality of FOUPs. In the stacker rack, a large number of storage space capable of storing loads such as parts or materials are provided.

The traveling carriage 2 is a transport device that travels along rails 4 to transport load automatically between the processors 1. The rails 4 are made of, for example, a guiding tape such as magnetic tape or the like, or a bar code or the like, attached to the floor surface. The rails 4 may be a guide provided on at least one of traveling carriage 2 side and rails 4 side so that running wheels (not shown) of the traveling carriage 2 run along the rails 4. Further, the rail 4 may be, for example, a guide or the like which is provided to be suspended from ceiling of the plant 10.

The traveling carriage 2 is provided with a polyarticular robotic arm or the like (not shown). The robotic arm can perform loading and unloading. As the traveling carriage 2, for example, an AGV (Automated Guided Vehicle) or an OHT (Overhead Hoist Transfer) can be used.

The traveling carriages 2 performs an automatic travel according to a transport task (travel order) allocated by a traveling carriage manager 3. The traveling carriage manager 3 will be described later. Specifically, the traveling carriage 2 starts the allocated transport task when it reaches a pre-specified task start time (start time). The traveling carriage 2 that started the transport task performs an automatic travel along the route according to the transport task. The traveling carriage 2 transports a designated load from a loading designated position (first designated position) P1 to an unloading designated position (second designated position) P2.

The automatic travel includes pausing for collision avoidance with another traveling carriage 2, traveling without load to the loading designated position P1, transporting the designated load from the loading designated position P1 to the unloading designated position P2, loading the load, and unloading the load. That is, in this preferred embodiment, the automatic travel of the traveling carriage 2 includes a series of operations from starting the transport tasks to (A) travel to the loading designated position P1, (B) loading at the loading designated position P1, (C) travel from the loading designated position P1 to the unloading designated position P2, and (D) completion of unloading at the unloading designated position P2.

As the task start time, for example, a time in which the traveling carriage 2 receives the transport task from the traveling carriage manager 3 can be set. However, this is not limiting. The task start time can be set to any time after receiving the transport task.

The transport task is a transport order for transporting a designated load, obtained by loading at the loading designated position P1, to the unloading designated position P2. In other words, the transport task includes position information of the loading designated position P1 and the unloading designated position P2, and the like. In addition, the transport task may include identification information of the load (designated load) as a subject for transporting from the loading designated position P1 to the unloading designated position P2.

In addition to the above, the transport task of this preferred embodiment includes a first designated time and a second designated time. The first designated time is a time specified with respect to the traveling carriage 2 to arrival at the loading designated position P1. The second designated time is a time (designated arrival time) specified with respect to the traveling carriage 2 to arrive at the unloading designated position P2.

The traveling carriage 2 includes a carriage controller 20 and a carriage signal transmitter/receiver 21, as shown in FIG. 2.

The carriage controller 20 may be a known computer. The carriage controller 20 includes a CPU (Central Processing Unit), a ROM (Read Only Memory), a RAM (Random Access Memory), an HDD (Hard Disk Drive), and the like, which are not shown.

The carriage controller 20 controls load transfer operation, automatic travel, and the like. The load transfer operation is performed by a transfer mechanism such as a polyarticular robotic arm or hoist (not shown) provided with the traveling carriage 2. Automatic travel is performed by travel mechanism (not shown) provided with the traveling carriage 2.

The carriage signal transmitter/receiver 21 enables radio communication with the traveling carriage manager 3. Any radio communication method can be used. For example, a wireless LAN can be used. The carriage signal transmitter/receiver 21 can transmit self-position information of the traveling carriage 2 to the traveling carriage manager 3 by radio communication. The carriage signal transmitter/receiver 21 can also receive the transport task allocated, and related information corresponding to the transport task, or the like. As the radio communication method, communication using leakage feeder wire or leakage coaxial cable can also be used.

The traveling carriage manager 3 is used to allocate each of a plurality of the transport tasks to any of a set of traveling carriages 2 which are managed. The transport tasks are provided by a production manager, etc. of the upper layer (not shown) to the traveling carriage manager 3. The traveling carriage manager 3 may be, for example, similar to the carriage controller described above, a known computer. The traveling carriage manager 3 includes a CPU (Central Processing Unit), a ROM (Read Only Memory), a RAM (Random Access Memory), a HDD (Hard Disk Drive), and the like (not shown).

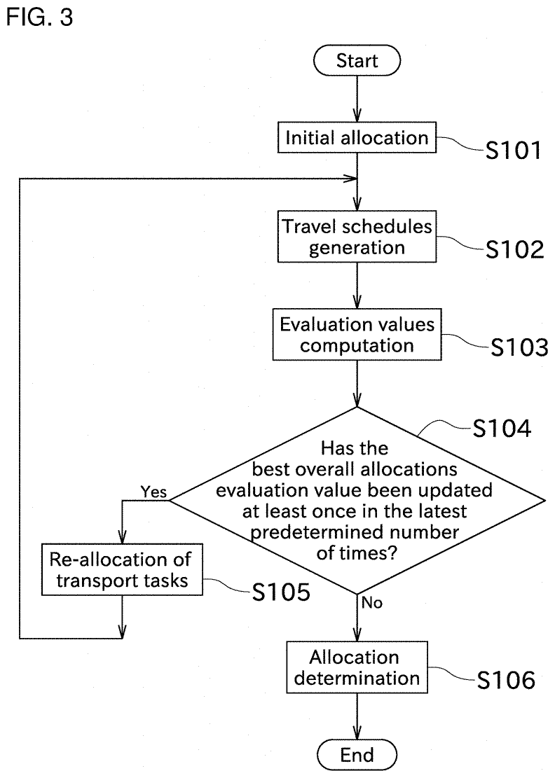

The traveling carriage manager 3 uses a transport task allocation method (travel order allocation method) shown in the flowchart of FIG. 3. The traveling carriage manager 3 determines which traveling carriage 2 each of the transport tasks is allocated to.

More specifically, the traveling carriage manager 3 performs transport task allocation with respect to transport tasks of a predetermined number (for example, the same number as the number of traveling carriages 2 managed). The transport task allocation is performed to allocate each transport task to each traveling carriage 2 using a transport task allocation method described below.

When the flow of FIG. 3 is started in a state that the transport tasks of a predetermined number are given, the traveling carriage manager 3 first performs an initial allocation (step S101). In the initial allocation, each of the transport tasks of a predetermined number, is provisionally allocated to one of the traveling carriages 2 managed. Step S101 corresponds to a first step.

In the initial allocation, the traveling carriage manager 3 provisionally allocates each of the transport tasks of the predetermined number, which are given, to any one of traveling carriage 2, one transport task at a time, until the provisional allocation is completed for all traveling carriages 2 managed.

More specifically, in the initial allocation, a set of combinations of the transport tasks and the traveling carriages 2 are provisionally generated. The number of combinations generated is a number obtained by multiplying the number of the traveling carriages 2 by the number of the transport tasks. At the same time or later, the traveling carriage manager 3 computes a task handling margin (initial evaluation value) in each of combinations generated as described above. The task handling margin represents a handling margin of the traveling carriage 2 with respect to the allocated transport task.

The task handling margin is computed, for example, as follows. A time, from the task start time to the second designated time specified by the transport task to be subject, is computed. This is referred to as scheduled transport time (scheduled handling time). The shortest time, required for the traveling carriage 2 to which the transport task to be subject is allocated to travel from a departure position, via loading designated position P1, to the unloading designated position P2, is computed. This is referred to as minimum travel time (shortest necessary time). Here, the departure position is the current position of the traveling carriage 2 at the task start time. The task handling margin is a time of the scheduled transport time minus the minimum travel time.

Among all task handling margins computed as above, in accordance with a descending order of the value of task handling margin (i.e., in order of the traveling carriage 2 having a larger handling margin with respect to the transport task), the traveling carriage manager 3 provisionally allocates the transport task corresponding to the task handling margin to the traveling carriage 2 corresponding to the task handling margin.

By allocating the transport tasks to the traveling carriages 2 in descending order of the task handling margin, it is possible to reduce or prevent a delay from occurring due to collision avoidance in a step S102 to be described later. In other words, it is possible to reduce the influence of collision avoidance on an error relative to the designated time.

By performing the initial allocation in this way, the transport tasks are provisionally allocated to traveling carriages 2 on a one-to-one basis. The initial allocation is not limited to being performed as described above. The transport tasks can be provisionally allocated to traveling carriages 2 in any order (e.g., at random).

After the initial allocation is performed as described above, the procedure goes to a step S102 (a second step) shown in FIG. 3. In the step S102, the traveling carriage manager 3 generates a route for the allocated transport task along which each of traveling carriages 2 travels.

In the step S102, the traveling carriage manager 3 generates travel schedules of the traveling carriages 2 for executing the transport tasks. The travel schedule includes a route and a collision avoidance information.

For example, considering only JIT performance, the route can be determined by searching the shortest path from the departure position to the loading designated position P1 and the shortest path from the loading designated position P1 to the unloading designated position P2. The search can be realized by using the Dijkstra algorithm or the like. The collision avoidance information is generated by using the Dijkstra algorithm or the like so as to realize collision avoidance with other traveling carriage 2 based on route determined by considering a JIT performance.

The route included in the travel schedule includes the loading designated position P1 and the unloading designated position P2, which are included in the transport task allocated to the traveling carriage 2.

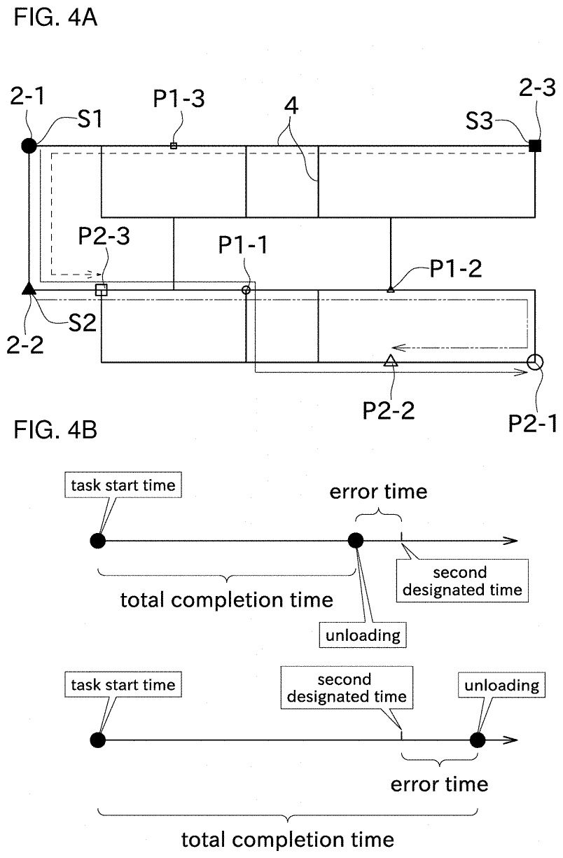

For example, as shown in FIGS. 4A and 4B, a first departure position S1, a first loading designated position P1-1, and a first unloading designated position P2-1 are included in the route (route indicated by thin lines in FIGS. 4A and 4B) of a first traveling carriage 2-1. The first traveling carriage 2-1 will travel to the first departure position S1, the first loading designated position P1-1, and the first unloading designated position P2-1.

A second departure position S2, a second loading designated position P1-2, and a second unloading designated position P2-2 are included in the route (route indicated by the chain line in FIGS. 4A and 4B) of a second traveling carriage 2-2. The second traveling carriage 2-2 will travel to the second departure position S2, the second loading designated position P1-2, and the second unloading designated position P2-2.

A third departure position S3, a third loading designated position P1-3, and a third unloading designated position P2-3 are included in the route (route indicated by the dotted line in FIGS. 4A and 4B) of a third traveling carriage 2-3. The third traveling carriage 2-3 will travel to the third departure position S3, the third loading designated position P1-3, and the third unloading designated position P2-3.

The collision avoidance information included in the travel schedule includes a pause position in the generated route and pause time in each pause position so that the traveling carriages 2 performing an automatic travel does not interfere with each other.

The traveling carriage 2 performs an automatic travel in accordance to the travel schedule generated as described above. Thus, the traveling carriage 2 can travel from the departure position to the loading designated position P1 and the unloading designated position P2 while avoiding collision with other traveling carriage 2. As a result, the designated load can be transported from the loading designated position P1 to the unloading designated position P2.

As shown above, the traveling carriage manager 3 generates the travel schedule of each of the traveling carriages 2 according to each of the transport tasks allocated by the initial allocation. Then the procedure goes to a step S103 (a third step) shown in FIG. 3.

In step S103, the traveling carriage manager 3 computes each of the task evaluation values (order evaluation values) J₁, when the traveling carriages 2 perform an automatic travel in accordance with each travel schedule generated according to the transport task. The task evaluation value J₁ represents compositely a JIT performance and a total completion time in an automatic travel performed by each of the traveling carriages 2 with respect to the transport task. In the computation, expression (1) below is used. Alternatively, the computation may be performed using the n-th power of absolute value.

$${J}_{i} = α ( \vert {\sum }_{t ∈ T} {K}_{t}^{l} - {J}_{ul} \vert + \vert {\sum }_{t ∈ T} {D}_{t}^{l} - {J}_{gl} \vert ) + β {\sum }_{t ∈ T} {D}_{t}^{l} \qquad ( 1 )$$

The traveling carriage manager 3 computes an overall allocations evaluation value J. The overall allocations evaluation value J is a value to judge whether good or not of overall allocations which are all of the present allocations for all transport tasks. In the computation, expression (2) below is used.

$$J = α {\sum }_{l ∈ L} \{ \vert {\sum }_{t ∈ T} {K}_{t}^{l} - {J}_{ul} \vert + \vert {\sum }_{t ∈ T} {D}_{t}^{l} - {J}_{gl} \vert \} + β {\sum }_{l ∈ L} {\sum }_{t ∈ T} {D}_{t}^{l} \qquad ( 2 )$$

As shown in expression (2), the overall allocations evaluation value J is a sum of each task evaluation value J₁ associated with each transport task.

K¹ₜ included in expression (1) and expression (2) above is a variable taking any of the binary values (specifically, 0 or 1). At a time t, K¹ₜ becomes 0 if loading corresponding to the transport task 1 has been completed, and becomes 1 if not. D¹ₜ is a variable taking any of the binary values (specifically, 0 or 1). At a time t, D¹ₜ becomes 0 if unloading corresponding to transport task 1 has been completed, and becomes 1 if not. Jᵤₗ is a third designated time that specifies timing at which the traveling carriage 2 arrived at the loading designated position P1 and loading has completed. That is, Jᵤₗ is a time of the first designated time plus loading time. J_{gl} is a fourth designated time that specifies timing at which the traveling carriage 2 arrived at the unloading designated position P2 and unloading has completed. That is, J_{gl} is a time of the second designated time plus unloading time. The third designated time Jᵤₗ and the fourth designated time J_{gl} may be pre-specified or computed based on the first designated time and the second designated time.

A portion of expression (3) below included in the above expression (1) and expression (2) represents an absolute value of an error time for loading of the traveling carriage 2. The error time is a difference between an estimated load time and the third designated time Jᵤₗ. The estimated load time is an estimated time at which the traveling carriage 2 is arrived at the loading designated position P1 and loading has completed. Instead of the absolute value of the error time, a value of the n-th power of the absolute value may be used (for example, when squaring, it is the same even if the original value is not made absolute).

$$\vert {\sum }_{t ∈ T} {K}_{t}^{l} - {J}_{ul} \vert \qquad ( 3 )$$

A portion of expression (4) below represents an absolute value of an error time for unloading of the traveling carriage 2 shown in FIG. 4B. The error time is a difference between an estimated unload time (estimated completion time) and the fourth designated time J_{gl}. The estimated unload time is an estimated time at which the traveling carriage 2 is arrived at the unloading designated position P2 and unloading has completed. Here, unloading time is substantially constant. Thus, the portion of expression (4) corresponds to an error time which is a difference between an estimated arrival time and the second designated time. The estimated arrival time is an estimated time at which the traveling carriage 2 is arrived at the unloading designated position P2. Instead of absolute value of the error time, a value of the n-th power of the absolute value may be used (for example, when squaring, it is the same even if the original value is not made absolute).

$$\vert {\sum }_{t ∈ T} {D}_{t}^{l} - {J}_{gl} \vert \qquad ( 4 )$$

A portion of expression (5) below is a total time taken by the traveling carriage 2 from the task start time at which the transport task is started until the transport task is completed. The total time is shown as the total completion time in FIG. 4B. In this preferred embodiment, the total completion time is a time, from the time when the transport task is started to the time when the transport task is completed, in which the traveling carriage to which the transport task to be subject is allocated is constrained.

$${\sum }_{t ∈ T} {D}_{t}^{l} \qquad ( 5 )$$

Based on the above travel schedule generated for each traveling carriage 2, with respect to each traveling carriage 2, the error time at the loading designated position P1, the error time at the unloading designated position P2, and the total completion time are computed by using expression (3), expression (4), and expression (5) above. In this way, it is possible to obtain the task evaluation value J₁ and the overall allocations evaluation value J with compositely considerations of the JIT performance and the total completion time.

α (first parameter) included in the above expression (1) and expression (2) is a weight for the JIT performance and can be adjusted as required. β (second parameter) is a weight for the total completion time and can be adjusted as required. At the extreme, if the second parameter β is set to zero, expression (1) and expression (2) above represent a task evaluation value J₁ and an overall allocations evaluation value J which takes only the JIT performance into account. If the first parameter a is set to zero, expression (1) and expression (2) above represent a task evaluation value J₁ and an overall allocations evaluation value J which take only the total completion time into account.

By adjusting weights for the JIT performance and the total completion time respectively, one can obtain the task evaluation value J₁ and the overall allocations evaluation value J (and thus the allocation of transport task) depending on how much a user emphasizes the JIT performance and the total completion time, respectively.

Thereafter, the traveling carriage manager 3 stores the task evaluation value J₁ and the overall allocations evaluation value J, combinations of the transport tasks and the traveling carriages 2 corresponding to the task evaluation value J₁ and the overall allocations evaluation value J, and the overall allocations, in association with each other. The task evaluation value J₁ and the overall allocations evaluation value J are computed in step S103 of FIG. 3.

Next, the traveling carriage manager 3 determines whether or not there was one or more iterative cycles in which the overall allocations evaluation value J was essentially improved, among iterative cycles of a predetermined number of times of most recent in which step S102 to step S105 were repeated until now (step S104). In repeating step S102 to step S105, a record of the best overall allocations evaluation value J is often updated in the iterative cycle near the starting. However, updating of the best overall allocation evaluation value J becomes more difficult as iterative cycle is repeated. That is, trends (improvement) of the overall allocations evaluation value J converges. step S104 is a decision as to whether or not search for making the overall allocations evaluation value J better should be aborted without continuing.

In step S104, if a record of the best overall allocations evaluation value (the smallest overall allocation evaluation value J among the overall allocation evaluation values J computed in each iterative cycle) is updated even in once among the predetermined iterative cycles of most recent, the procedure goes to step S105 (a fourth step). If the update has not occurred, the search is aborted and the procedure goes to step S106.

In step S105, the traveling carriage manager 3 selects the transport task corresponding to the largest (worst) task evaluation value J_{1_max} among a plurality of task evaluation values J₁ which are computed in step S103 as a priority solution task (priority travel order). Then, the traveling carriage manager 3 determines the traveling carriage 2 to which the obtained priority solution task is to be allocated, as follows.

Specifically, the traveling carriage manager 3 provisionally allocates the priority solution task determined as described above to the head of all traveling carriages 2. Allocating the priority solution task to the head of the traveling carriages 2 indicates that the priority solution task is allocated so as to be executed by the traveling carriage 2 firstly. In other words, if the other transport task has already been allocated to the traveling carriage 2, the priority solution task is allocated to the traveling carriage 2 so as to be executed preferentially over the other transport task.

Then, with respect to the priority solution task, the traveling carriage manager 3 re-generates the above travel schedule for each traveling carriage 2 to perform an automatic travel. The traveling carriage manager 3 computes each priority task evaluation value J₁₁ in association with each traveling carriage 2. The priority task evaluation value J₁₁ is the above-mentioned task evaluation value when traveling carriage 2 performs an automatic travel in accordance with each generated travel schedule.

Next, the traveling carriage manager 3 allocates the priority solution task to the head of the traveling carriage 2 corresponding to a priority task evaluation best value (best order evaluation value). The priority task evaluation best value is the smallest value among the priority task evaluation values J₁₁ for the priority solution task. Then, the procedure goes back to step S102.

It is also conceivable that the traveling carriage 2, for the priority task evaluation best value, matches traveling carriage 2 to which the priority solution task was originally allocated. In this case, the allocation cannot be changed. Therefore, the traveling carriage manager 3 assumes that the transport task, corresponding to the second highest (worst) task evaluation value J₁ among the task evaluation values J₁, is the priority solution task. Then the traveling carriage manager 3 determines the traveling carriage 2 of subject to which the priority solution task is to be allocated, similarly to above. Thus, in step S105, the currently allocated traveling carriage 2 is changed for at least one transport task. Then, the procedure goes back to step S102.

In step S102, the traveling carriage manager 3 generates a travel schedule of each traveling carriage 2 with respect to the overall allocations after being changed in step S105.

With respect to each transport task allocated to the traveling carriage 2, time is measured from the pre-specified task start time. Thus, the task evaluation value J₁, corresponding to the transport task allocated after the priority solution task, is likely larger than the task evaluation value J₁ corresponding to another transport task. Therefore, it is likely that the transport task allocated after the priority solution task will be reallocated to the other traveling carriage 2 as a priority solution task in the next and subsequent times.

Thus, the traveling carriage manager 3 repeatedly executes from step S102 to step S105. Each time step S105 is executed, the traveling carriage manager 3 stores the obtained the overall allocations and the corresponding overall allocations evaluation value J.

If it is determined in step S104 that trends of best overall allocations evaluation value J has converged and no further significant improvement of the overall allocations evaluation value J is expected, the traveling carriage manager 3 determines the overall allocations corresponding to the overall allocations evaluation value J having the smallest value among the stored overall allocations evaluation values J (step S106). Step S106 corresponds to a fifth step.

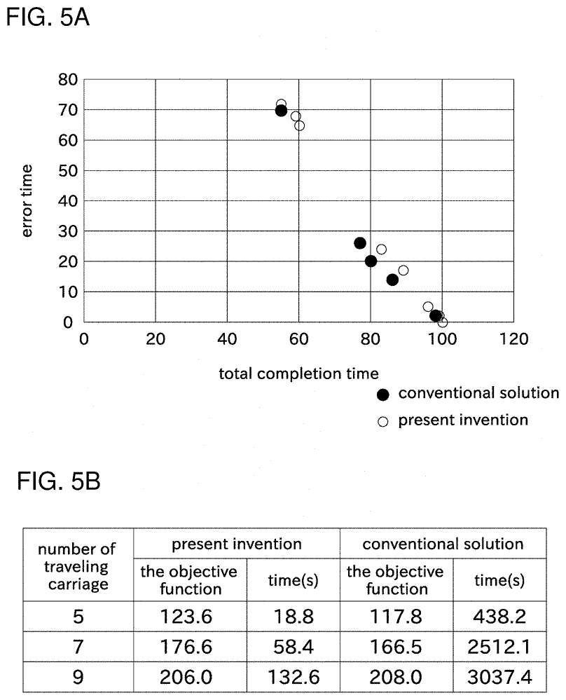

As shown in graph in FIG. 5A, which shows a relationship of the JIT performance and the total completion time, the shorter the error time (better JIT performance), the longer the total completion time tends to be. That is, if only the JIT performance is considered, the total completion time becomes long and transport efficiency is lowered. On the other hand, if only the total completion time is considered, the JIT performance becomes worse and work efficiency of processor 1 and the like deteriorates. By using the transport task allocation method of this preferred embodiment, depending on adjustment for α and β by user, it is possible to easily obtain allocations of transport tasks according to the productive characteristics of plant 10 and the like.

FIGS. 5A and 5B show the results of simulating each of transport task allocation method of this preferred embodiment and the conventional exact solution such as mathematical programming under equivalent conditions. The objective function in FIG. 5B indicates the value of expression (2) described above. As shown in FIG. 5A, the transport task allocation method of this preferred embodiment can obtain allocations substantially similar to that of the conventional solution.

As described above, the transport task allocation method of this preferred embodiment uses a method (so-called heuristic solution) in which, in the overall allocations provisionally set, the traveling carriage 2 to be allocated is determined while giving priority to the transport task having the worst task evaluation value J₁. Thus, as shown in FIG. 5B, it is confirmed that the method enables obtaining in a shorter time the overall allocations suitable for request of user compared to that of the conventional mathematical programming.

As described above, the transport system includes a set of traveling carriages 2 that perform an automatic travel. In the transport task allocation method of this preferred embodiment, the transport task including position information of the loading designated position P1 and the unloading designated position P2 is allocated to the traveling carriage 2. The transport task allocation method includes step S101, step S102, step S103, step S105, and step S106. In step S101, each of the transport tasks is provisionally allocated to a set of traveling carriage 2. In step S102, for each of a set of traveling carriages 2, a travel schedule in which the traveling carriage 2 travels from a departure position to in order of the loading designated position P1 and the unloading designated position P2 included in the transport task provisionally allocated in step S101. The travel schedule is determined such that the traveling carriages 2 performing an automatic travel does not interfere with each other. In step S103, the task evaluation value J₁ for each of the transport tasks and the overall allocations evaluation value J for overall allocations, in the case where each of the traveling carriage 2 performs an automatic travel in accordance with each of the travel schedules determined in step S102, are computed. The overall allocations are all of combinations in which all the transport tasks are allocated to a set of the traveling carriages 2, respectively. In step S105, based on the task evaluation value J₁ computed in step S103, the traveling carriage 2 currently allocated for at least one of the transport tasks is changed. In step S106, when it is determined that trends of best overall allocations evaluation value among a plurality of the overall allocations evaluation values J obtained by repeatedly executing step S102, step S103, and step S105 has converged, the overall allocations corresponding to best overall allocations evaluation value J of latest are determined.

As a result, it is possible to determine allocations having a good overall allocations evaluation value J in the computation procedure of a short time. Accordingly, the configuration of this preferred embodiment is particularly suitable in a transport system of a large-scale plant, a large automatic stocker, and the like, having a large number (e.g., several tens to hundreds, or thousands) of traveling carriages 2.

Further, in the transport task allocation method of this preferred embodiment, in step S105, the transport task, corresponding to the task evaluation value J₁ having the largest value among all the task evaluation values J₁ computed in step S103, is provisionally allocated to each of a set of the traveling carriages 2 as a priority solution task. In step S105, the travel schedule of each traveling carriage 2 is determined for the priority solution task. Then, each of the task evaluation values J₁, in the case where each the traveling carriage 2 travels in accordance with the travel schedule for the determined priority solution task, is computed in association with each of the traveling carriage 2. In step S105, the priority solution task is allocated to traveling carriage 2 corresponding to the best task evaluation value among all the task evaluation values J₁ which are computed.

As a result, with respect to the transport task provisionally allocated, the transport task corresponding to an allocation with the worst evaluation is reallocated preferentially. This enables reducing processing time to find the overall allocations close to the ideal.

Further, in the transport task allocation method of this preferred embodiment, the overall allocations evaluation value J is computed based on the error time and the total completion time. The error time is a difference between the estimated arrival time and the second designated time which is pre-specified. The estimated arrival time is an estimated time at which the traveling carriage 2, traveling in accordance with the travel schedule, is arrived at the unloading designated position P2. The total completion time is a time from the pre-specified task start time until the traveling carriage 2 is arrived at the unloading designated position P2 and unloading has completed. The best overall allocations evaluation value is the overall allocations evaluation value J having a minimum value among a plurality of the overall allocations evaluation values J.

As a result, it is possible to obtain allocations close to the ideal by considering both the JIT performance and the total completion time. The JIT performance is represented by an error between the estimated unload time and the second designated time, by square values of the error, or the like.

Further, in the transport task allocation method of this preferred embodiment, the overall allocations evaluation value J is computed based on the error time weighted by α and the total completion time weighted by 13. Each of α and β is adjustable.

As a result, by adjusting each parameter, it is possible to obtain allocations corresponding to the degree of importance with respect to the JIT performance and the total completion time respectively. It is also possible to obtain allocations considering only one of the JIT performance and the total completion time, by setting one of the weights to zero.

Further, in the transport task allocation method of this preferred embodiment, the overall allocations evaluation value J is computed based on the error time and the total completion time. The error time is a difference between the estimated unload time and the second designated time which is pre-specified. The estimated unload time is an estimated time at which the traveling carriage 2, traveling in accordance with the travel schedule, is arrived at the unloading designated position P2 and unloading has completed. The total completion time is a time from the pre-specified task start time until the traveling carriage 2 is arrived at the unloading designated position P2 and unloading has completed. The overall allocations evaluation value J is a sum of each of the task evaluation value J₁ in overall allocations corresponding to the overall allocations evaluation value J.

As a result, it is possible to obtain allocations close to the ideal by considering both the JIT performance and the total completion time, with respect to the travel of one of the traveling carriages 2.

Further, in the transport task allocation method of this preferred embodiment, the transport task includes the second designated time. In step S101, for each of the transport tasks, the traveling carriage 2 which is a subject to which the transport task is provisionally allocated is determined based on each of the task handling margins in the case where the transport task is allocated to each of the vehicles. The task handling margin is a value based on a margin time obtained by subtracting a minimum travel time from the scheduled transport time. The minimum travel time is the shortest time required for the vehicle to which the travel order is allocated to travel from the departure position to the unloading designated position P2. The scheduled handling time is a time from the task start time which is pre-specified to the second designated time. Task handling margins are computed for all combinations when each of all the transport tasks is provisionally allocated to each of all the traveling carriages 2, so that one of all the transport tasks is provisionally allocated to each of all the traveling carriages 2. In step S101, based on all the computed task handling margins, in order of the larger task handling margins, the transport task, corresponding to the task handling margin, is provisionally allocated to the traveling carriage 2 corresponding to the task handling margin.

As a result, in the initial allocation, a plurality of transport tasks can be reasonably provisionally allocated to a set of the traveling carriages 2. This enables reductions in the time required to obtain the overall allocations close to the ideal.

Further, in the transport task allocation method of this preferred embodiment, the traveling carriage 2 is a traveling carriage that loads a designated load at the loading designated position P1 and unloads the load at the unloading designated position P2. The transport task is a transport order to cause the traveling carriage 2 to travel to the loading designated position P1 and then to travel to unloading designated position P2.

As a result, it is possible to obtain in a short time the overall allocations in which the transport task is properly allocated to each of a set of traveling carriages 2.

While some preferred embodiments of the present invention have been described above, the above configurations may be modified, for example, as follows.

After completion of a transport task, the traveling carriage 2 may stop at a current position, may stop at a pre-specified standby position, or may wait with traveling along a pre-specified standby route. From the viewpoint of ease of travel schedule generation, it is preferable that the traveling carriage 2 after completing transport task stops at any position and waits.

The traveling carriage 2, instead of magnetic tape, may travel along a travel line configured from other materials, or may perform an automatic travel without a travel line formed from tape or the like.

The traveling carriage 2 is not limited to an unmanned carrier vehicle such as AGV. For example, a rail unmanned carrier vehicle (RGV; Rail Guided Vehicle), or an overhead traveling vehicle (OHS; Over Head Shuttle) or the like can be used.

A transport area of the traveling carriage 2 may be pre-specified. In this case, the traveling carriage 2 may wait at a position where the transport task has been completed, or may wait at a standby position pre-specified in the transport area. The traveling carriage manager 3 may be provided for each area.

In respect to only the unloading designated position P2, the travel of the traveling carriage 2 can be determined to take into account both the JIT performance and the total completion time.

The traveling carriage manager 3 may perform the above transport task allocation for more or less transport tasks than the number of traveling carriage 2 managed.

The first designated time and the second designated time may be designated as the third designated time Jᵤₗ and the fourth designated time J_{gl}, instead of time to arrive to the loading designated position P1 and time to arrival to the unloading designated position P2. Instead of the first designated time and the second designated time, it is also possible to use a loading period and an unloading period.

The operations relating to loading and unloading may be instructed by the transport tasks, or maybe instructed from the traveling carriage manager 3 separately after arrival to the loading designated position P1 or the unloading designated position P2.

In addition to the transport system 100, the transport task allocation methods of preferred embodiments of the present invention can also be applied to other routing systems including a set of vehicles.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A method for allocating a travel order including positional information of a first designated position and a second designated position to a vehicle in a routing system including a set of vehicles for an automatic travel, the method comprising:
a first step of provisionally allocating each of a plurality of travel orders to any one of the vehicles;
a second step of determining, for each of the set of the vehicles, a travel schedule in which the vehicle travels from a departure position to the first designated position and the second designated position included in the travel order provisionally allocated in the first step, such that the vehicles performing an automatic travel do not interfere with each other;
a third step of computing an order evaluation value for each of the travel orders and an overall allocations evaluation value for overall allocations which are all of the combinations in which all the travel orders are allocated to the set of the vehicles, respectively, when each of the vehicles performs an automatic travel in accordance with each of the travel schedules determined in the second step;
a fourth step of changing the vehicle currently allocated for at least one of the travel orders, based on the order evaluation value computed in the third step; and
a fifth step of determining the overall allocations corresponding to best overall allocations evaluation value of latest when it is determined that trends of the best overall allocations evaluation value among a plurality of the overall allocations evaluation values obtained by repeatedly executing the second step, the third step, and the fourth step has converged.

2. The method for allocating the travel order according to claim 1, wherein in the fourth step:
the travel order, corresponding to the order evaluation value having the worst value of all the order evaluation values computed in the third step, is provisionally allocated to each of the set of the vehicles as a priority travel order;
the travel schedule of each of the vehicles is determined for the priority travel order, and each of the order evaluation values, when each of the vehicles travels in accordance with the travel schedule for the determined priority travel order, is computed in association with each of the vehicles; and
the priority travel order is allocated to the vehicle corresponding to the best order evaluation value among all the order evaluation values which are computed.

3. The method for allocating the travel order according to claim 1, wherein the overall allocations evaluation value is computed based on:
an error time which is a difference between an estimated arrival time at the second designated position and a pre-specified designated arrival time of the vehicle traveling in accordance with the travel schedule; and
a total completion time which is a time from a pre-specified start time until the vehicle arrives at the second designated position; and
the best overall allocations evaluation value is the overall allocations evaluation value having a minimum value among a plurality of the overall allocations evaluation values.

4. The method for allocating the travel order according to claim 3, wherein
the overall allocations evaluation value is computed based on the error time weighted by a first parameter and the total completion time weighted by a second parameter; and
each of the first parameter and the second parameter is adjustable.

5. The method for allocating the travel order according to claim 1, wherein the order evaluation value is computed based on:
an error time which is a difference between an estimated arrival time at the second designated position and a pre-specified designated arrival time of the vehicle traveling in accordance with the travel schedule; and
a total completion time from a pre-specified start time until the vehicle arrives at the second designated position; and
the overall allocations evaluation value is a sum of each the order evaluation value in the overall allocations corresponding to the overall allocations evaluation value.

6. The method for allocating the travel order according to claim 1, wherein
the travel order includes designated arrival time which is a time to arrival to the second designated position;
in the first step, for each of the travel orders, the vehicle which is a subject to which the travel order is provisionally allocated, is determined based on each of initial evaluation values when the travel order is allocated to each of the vehicles;
the initial evaluation value is a value based on a margin time obtained by subtracting a shortest necessary time required for the vehicle to which the travel order is allocated to travel from a current position to the second designated position, from a scheduled handling time from a pre-specified start time to the designated arrival time;
the initial evaluation values are computed for all combinations when each of all the travel orders is provisionally allocated to each of all the vehicles so that one of all the travel orders is provisionally allocated to each of all the vehicles; and
in the first step, based on all the computed initial evaluation values, in order of the larger initial evaluation values, the travel order corresponding to the initial evaluation value is provisionally allocated to the vehicle corresponding to the initial evaluation value.

7. The method for allocating the travel order according to claim 1, wherein
the vehicle is a traveling carriage that loads a designated load at the first designated position, which is a designated loading position, and unloads the load at the second designated position, which is a designated unloading position;
the travel order is a transport order for causing the traveling carriage to travel to the first designated position and then to travel to the second designated position.

8. A controller to determine the vehicle to be allocated to the travel order using the method for allocating the travel order according to claim 1.

9. A transport system comprising:
the controller according to claim 8; and
a set of transporters to perform an automatic travel based on the travel order allocated by the controller.
